(19) United States
(12) Patent Application Publication
(10) Pub. No.: US 2009/0207192 A1
(43) Pub. Date: Aug. 20, 2009

(54) Data line driving circuit outputting gradation signals in different timing, display device, and data line driving method

(75) Inventor: Yoshiharu Hashimoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/320,783

(22) Filed: Feb. 4, 2009

(30) Foreign Application Priority Data
Feb. 15, 2008 (JP) 2008-034747

(51) Int. Cl. G09G 5/10; G09G 3/36

(52) U.S. Cl. 345/690; 345/88

(57) ABSTRACT

A neutralization switch is provided for each of the RGB (red, green and blue) colors to control the charge neutralization periods of those RGB colors respectively. Each of the neutralization switches has an on-resistance value that differs among the RBG colors. A low value is set for the on-resistance value of the neutralization switch of the data line corresponding to green of which visual sensitivity is high so as to shorten the charge neutralization period, thereby extending the driving periods in which the subsequent gradation signals are to be output respectively.

### BACKGROUND OF THE INVENTION

1. Field of the Invention

The present invention relates to a data line driving circuit for driving data lines of a display device, a display device, and a data line driving method, more particularly to a data line driving circuit of which output timing differs among gradation signals, a display device, and a data line driving method.

2. Description of Related Art

As one of typical display devices, there is a matrix type display device in which pixels are disposed in a matrix of columns and rows. The matrix type display device includes scanning lines for selecting pixel lines and data lines for receiving supply of gradation signals corresponding to pixel gradations. A pixel includes a TFT (Thin Film Transistor) that functions as a switching element, as well as a pixel electrode. Each pixel is disposed at an intersecting point of a scanning line and a data line. In a liquid crystal panel, liquid crystal is filled between each pixel electrode and each common electrode facing the pixel electrode.

Such a liquid crystal panel employs an inversion driving system that inverts the polarity to be applied to each pixel electrode. This means that pixels are driven in terms of alternating current. In case of a large liquid crystal panel, a dot inversion driving system is employed. In case of this dot inversion driving system, the common electrode voltage (Vcom) is fixed and the polarity of each gradation signal to be applied to each data line is inverted in each horizontal period and in each frame so that the polarity is inverted between adjacent pixels.

In case of a conventional data line driver IC, gradation signals are output from all the output terminals at the same timing, so the current is concentrated in the power supply line, thereby the EMI (Electro Magnetic Interference) comes to rise.

The patent document 1 discloses a method for reducing the EMI. The method varies the output timing among gradation signals to avoid such current concentration in the power supply line.
[Patent document 1] Japanese Unexamined Patent Application Publication No. 2005-078096

### SUMMARY

The present inventor has made the following inspection and analysis with respect to the conventional techniques disclosed in the above documents. According to the method disclosed in the patent document 1, if the output timing is varied among data lines, the later the data line is driven, the shorter the driving period becomes. Consequently, the power of writing into pixels comes in short, thereby the image quality including the contrast is lowered.

The data line driving circuit of an exemplary aspect of the present invention is used in a display device provided with a plurality of data lines. The circuit includes a first buffer that outputs gradation signals in accordance with image data to a first data line; a second buffer that outputs gradation signals in accordance with image data to a second data line; and a control block that controls so that the charge neutralization period of the first data line becomes shorter than the charge neutralization period of the second data line and the gradation signals are to the first data line earlier than those output to the second data line.

The data line driving method of an exemplary aspect of the present invention is used in a display device provided with a plurality of data lines. The method includes the steps of (a) controlling so that the charge neutralization period of the first data line becomes shorter than that of the second data line; and (b) controlling so that the gradation signals are output to the first data line earlier than those output to the second data line.

According to the exemplary aspects of the present invention, therefore, it is possible to temporally disperse the current flowing in the power supply line of the driving block and reduce the EMI by varying the output timing among gradation signals of the first and second data lines respectively. Furthermore, it is possible to quicken the output timing of each of the gradation signals of the first and second data lines by shortening the charge neutralization period of the first data line. Consequently, the driving period of each of the gradation signals of the second data line is extended, thereby the time of writing into pixels is extended. As a result, the image quality is improved.

### BRIEF DESCRIPTION OF THE DRAWINGS

FIG. 1 is a block diagram of a data line driving circuit employed for a display device of the present invention;

FIG. 2 is a detailed circuit diagram of a driving block in a first exemplary embodiment of the present invention;

FIG. 3 is a circuit diagram of a neutralization switch block in the first to third exemplary embodiments of the present invention;

FIG. 4 is a timing chart in the first exemplary embodiment of the present invention;

FIG. 5 is a diagram for showing a rate of the area of the driving block in the first exemplary embodiment of the present invention;

FIG. 6 is a diagram for showing waveforms of data lines in the first exemplary embodiment of the present invention;

FIG. 7 is a detailed circuit diagram of the driving block in the second exemplary embodiment of the present invention;

FIG. 8 is a diagram for showing a rate of the area of the driving block in the second exemplary embodiment of the present invention;

FIG. 9 is a diagram for showing signal waveforms of data lines in the second exemplary embodiment of the present invention;

FIG. 10 is a detailed circuit diagram of the driving block in the third exemplary embodiment of the present invention;

FIG. 11 is a timing chart in the third exemplary embodiment of the present invention;

FIG. 12 is a graph for showing the characteristics of an output switch provided in the driver IC in the third exemplary embodiment of the present invention; and

FIG. 13 is a diagram for showing signal waveforms of data lines in the third exemplary embodiment of the present invention.

### DETAILED DESCRIPTION OF THE EXEMPLARY EMBODIMENTS

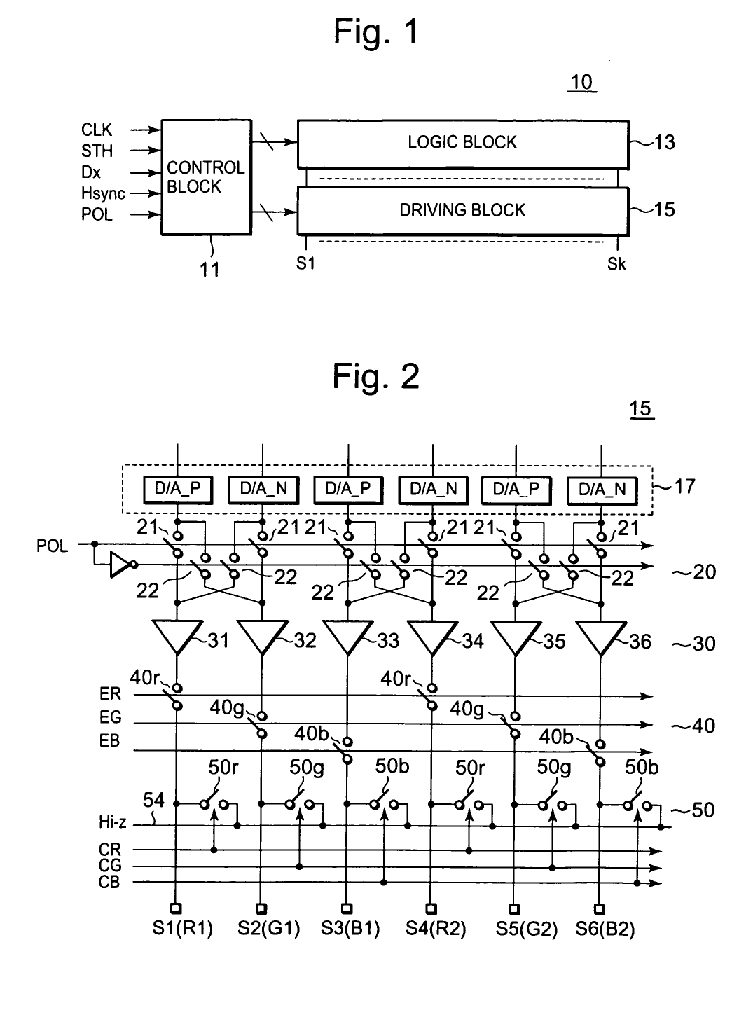

A data line driving block 10, as shown in FIGS. 1, 2, and 4, is intended for use in a display device provided with a plurality of data lines. The data line driving circuit 10 is configured so as to provide its first data line G1 with a first buffer 32 that outputs gradation signals corresponding to image data, its second data line R1 with a second buffer 31 that outputs gradation signals according to image data respectively, and a control block 11 that controls so that the charge neutralization period (t0 to t1) of the first data line G1 becomes shorter than that (t0 to t3) of the second data line R1 and so that the output timing t2 of the gradation signal to the first data line becomes earlier than that t4 of the gradation signal to the second data line.

As shown in FIG. 2, the data line driving circuit 10 may also include a first neutralization switch 50g corresponding to the charge neutralization of the first data line G1 and a second neutralization switch 50r corresponding to the charge neutralization of the second data line R1. And the on-resistance value of the first neutralization switch 50g may be set smaller than that of the second neutralization switch 50r.

The gate width of the transistors of the first neutralization switch 50g may be wider than that of the transistors of the second neutralization switch 50r.

The first data line G1 should preferably correspond to green and the second data line R1 should preferably correspond to another color (e.g., red).

The through rate of the gradation signals of the second data line R1 should preferably be higher than that of the first data line G1.

The data line driving circuit shown in FIG. 2 should preferably include a first output switch 40g provided between the first buffer 32 and the first data line G1 and a second output switch 40r provided between the second buffer 31 and the second data line R1 and the on-resistance value of the first output switch 40g should preferably be larger than that of the second output switch 40r.

The gate width of the transistors of the first output switch 40g should preferably be narrower than that of the transistors of the second output switch 40r.

The total width of the gate width of the transistors of the first neutralization switch 50g and that of the first output switch 40r should preferably be equal to the total width of the gate width of the transistors of the second neutralization switch 50r and that of the second output switch 40r.

The charge neutralization period (t0 to t1) of the first data line G1 may be zero.

At this time, the neutralization switch 50g corresponding to the charge neutralization of the first data line G1 may be omitted.

In the data line driving block 10, the on-resistance value of the first or second output switch should preferably be high in the center portion of the driver IC and low at the right and left ends of the driver IC.

Furthermore, the display device should preferably be provided with the data line driving circuit 10 described above.

Furthermore, as shown in FIGS. 2 and 4, the data line driving method employed for a display device provided with a plurality of data lines should preferably include a step of controlling so that the charge neutralization period (t0 to t1) of the first data line G1 becomes shorter than that (t0 to t3) of the second data line R1 and a step of controlling so that the output timing t2 of the gradation signal to the first data line G1 becomes earlier than that t4 of the gradation signal to the second data line R1.

In the data line driving method described above, the charge neutralization period of the first data line G1 may be zero.

### First Exemplary Embodiment

Hereunder, there will be described a data line driving circuit in this first exemplary embodiment of the present invention with reference to the accompanying drawings. In principle, in all those drawings, the same or similar reference numerals will be used for the same or similar components, avoiding redundant description. And as needed, a plurality of elements having the same component will be distinguished by subscripts respectively. When there is no need to distinguish those elements, the subscripts will be omitted.

The matrix type display device driven by the data line driving circuit of the present invention includes scanning lines for selecting pixel lines and data lines for receiving supply of gradation signals corresponding to pixel gradations. A pixel includes a TFT (Thin Film Transistor), which is a switching element, as well as a pixel electrode. Each pixel is disposed at an intersecting point of a scanning line and a data line. In a liquid crystal panel, liquid crystal is filled between each image electrode and a common electrode facing the image electrode. A color liquid crystal panel has pixels of three colors R (red), G (green), and B (blue).

Each pixel has a fixed voltage (Vcom) in its common electrode. The polarity of each gradation signal supplied to a data line is inverted in each horizontal period and in each frame, so that the polarity is inverted between adjacent pixels according to the dot inversion driving system. Here, as known well, in prior to supplying a gradation signal to a data line in accordance with object image data, precharging and charge neutralization (also referred to as charge sharing/charge collecting) are carried out. The present invention regards such precharging and charge neutralization as different functions.

Precharging is required to supply a fixed voltage (precharge voltage) to a data line before supplying a horizontal period gradation signal to the data line, thereby quickening the voltage of writing to pixels. Assume now that the low potential of the driving block is defined as VSS, the high potential as VDD, Vₚₚ=VDD−VSS is satisfied. The precharge voltage thus becomes, for example, around ¾ of the Vpp and around ¼ of the Vpp. If the precharge voltage is under the target gradation voltage, however, the write voltage cannot be quickened. As a result, the power will be consumed wastefully. Furthermore, if such precharging is carried out for all the data lines simultaneously, the current is concentrated in the precharge power supply line, so the EMI rises significantly. This is why it is required to vary the output timing among gradation signals, as well as to vary the timing of precharging among those gradation signals.

Furthermore, the current in the logic block increases while image data is transferred from a latch A to a latch B initially in the horizontal period. And when the image data changes, the level is shifted and the current is concentrated into the power supply line (VSS/VDD) of the driving block. Consequently, if both precharging and latching are carried out simultaneously, the current is concentrated in the power supply line (VSS/VDD), thereby the EMI rises. In this case, latching and precharging should be started at different timings to reduce the EMI value.

On the other hand, charge neutralization causes the neutralization switch be turned on to short-circuit object data lines with each other, thereby neutralizing the positive and negative charges before supplying gradation signals in the horizontal period of those data lines driven into positive or negative polarity in the preceding horizontal period. The power consumption is thus reduced. At this time, the charges are moved between data lines through each neutralization switch, so that the current is dispersed spatially and prevented from concentration in the power supply line of the driving block. Consequently, the EMI can be reduced more than precharging. Such charge neutralization and latching can be started together, thereby the subsequent driving period can be extended.

When outputting a gradation signal to a data line according to object image data, a current flows in the power supply line through a buffer. Thus if the output timing is varied among gradation signals, the current flow into the power supply line of the driving block can be dispersed temporally. In this exemplary embodiment, the data line charge neutralization period differs among colors, so that the charge neutralization period is set shorter than the conventional one with respect to a specific color, thereby extending the driving period of the subsequent gradation signals. In this case, if the driving period is varied between the same color data lines, display unevenness might occur. This problem can be avoided as long as the same driving period is kept.

FIG. 1 is a block diagram of the data line driving circuit 10 in this exemplary embodiment. The data line driving circuit 10 includes a control block 11, a logic block 13, and a driving block 15. The data line driving circuit 10 is integrated, for example, into a semiconductor chip (driver IC) for use in a TCP (Tape Carrier Package) or a COF (Chip on Film). The data lines of a liquid crystal panel are connected to the leads of the TCP and COF through an ACF (Anisotropic Conductive Film). Those data lines may be connected through bumps and ACF formed on the driver IC (referred to as a COG (Chip on Glass). However, in any semiconductor manufacturing apparatus, it is difficult to integrate the data line driving circuit 10 completely in one driver IC. This is why a plurality of driver ICs are used in one liquid crystal panel. For example, in case of a full HD (1920×RGB×1080 pixels) liquid crystal panel, the number of data lines is 5760 and 8 720-output driver ICs are used.

The present invention premises that a data line corresponding to red pixels is a data line R, a data line corresponding to green pixels is a data line G, and a data line corresponding to blue pixels is a data line B. And in order to simplify the description of this exemplary embodiment, the data lines will be limited only to 6, which are R1, G1, B1, R2, G2, and B2. And the output terminals of the driver IC, connected to those data lines R1, G1, B1, R2, G2, and B2 are defined as S1 to S6.

The control block 11 receives a clock signal CLK, a start pulse signal STH, image data Dx, a horizontal synchronization signal Hsync, a polarity signal POL, etc. from the timing controller (TCON) provided outside the driver IC. And according to those signals received from the TCON, the control block 11 generates control signals used to control the logic block 13 and the driving block 15 and outputs those signals each object block. Timing differences are generated by a counter circuit, a delay circuit, etc. synchronized with the clock signal CLK.

If a plurality of driver ICs are used, the disposition of the control block 11 might generate uneven blocks, since the output terminals Sk and S1 of the first and second driver ICs are adjacent to each other. For example, if the control block 11 is disposed at the right end of the IC chip and control signals are supplied to the left side, a delayed control signal comes to cause the output timing to vary between the output terminals S1 and Sk. To avoid this, the control block 11 is disposed at both right and left ends of the chip and two output switches 40 are disposed to supply control signals to the center of the chip, thereby preventing such generation of uneven blocks.

The logic block 13 includes a data buffer, a shift register, a data latch, etc. (not shown). Usually, the data latch consists of two stages; a latch A for latching image data Dx transferred from the data buffer and a latch B for latching image signals from the latch A sequentially according to the sampling signals output from the shift register. The logic block 13 renews the order of image data so as to make it correspond to its object data line.

The operation voltage differs between the logic block 13 and the driving block 15, so a level shift block is provided between the logic block 13 and the driving block 15. Control signals output from the control block 11 are also supplied to the driving block 15 through the level shift block.

Next, there will be described a configuration of the driving block with reference to FIG. 2. The driving block 15 in this exemplary embodiment includes a D/A conversion block 17 for converting digital signals (image data Dx) to analog signal gradation voltages; a polarity switching block 20, a buffer block 30, an output switch block 40, a neutralization switch block 50, and a gradation voltage generation block (not shown) for supplying a plurality of positive gradation signals and a plurality of negative gradation voltages to the D/A conversion block 17.

The D/A conversion block 17 includes a positive polarity D/A converter for outputting gradation voltages having the positive polarity with respect to a reference voltage and a negative polarity D/A converter for outputting gradation voltages having the negative polarity with respect to the reference voltage. The D/A conversion block 17 inputs image data and selects a gradation signal according to each image data, then outputs the selected gradation signal.

The buffer block 30 carries out impedance conversion from high impedance gradation voltages selected according to object image data in the D/A conversion block 17 to low impedance gradation signals. Here, it is premised that what is not buffered yet is referred to as a gradation voltage and what is already buffered is referred to as a gradation signal. A voltage follower can be used as those buffers respectively. Buffers used for driving the data lines R1, G1, B1, R2, G2, and B2 are defined as buffers 31 to 36.

The polarity switching block 20 is provided between the D/A conversion block 17 and the buffer block 30. The polarity switching block 20 switches between the positive polarity gradation voltage and the negative polarity gradation voltage inputted from the D/A conversion block 17 according to the polarity signal POL output from the control block 11 and outputs the results to the buffer block 30. When the polarity signal POL denotes the H level, the switch 21 is turned on and the switch 22 is turned off to output the positive polarity gradation voltage to the buffers 31, 33, and 35 and the negative polarity gradation voltage to the buffers 32, 34, and 36. When the polarity signal denotes the L level, the switch 21 is turned off and the switch 22 is turned on to output the negative polarity gradation voltage to the buffers 31, 33, and 35 and the positive polarity gradation voltage to the buffers 32, 34, and 36. Consequently, when the polarity signal POL denotes the H level, the positive polarity gradation signal is output to the data lines R1, B1, and G2 and the negative polarity gradation signal is output to the data lines G1, R2, and B2. When the polarity signal POL denotes the L level, the negative polarity signal is output to the data lines R1, B1, and G2 and the positive polarity gradation signal to the data lines G1, R2, and B2.

The output switch block 40 is provided between the buffer block 30 and each data line. Upon charge neutralization, the output switch block 40 is turned off to disconnect the buffer block 30 from each data line. Upon gradation signal output, the output switch block 40 is turned on to connect the buffer block 30 to each data line. Here, it is premised that the output switches corresponding to the data lines R, G, and B are output switches 40r, 40g, and 40b. The output switches 40r, 40g, and 40b are controlled by the control signals ER, EG, and EB output from the control block respectively.

The neutralization switch block 50 neutralizes both positive and negative charges accumulated in data lines by short-circuiting those data lines to each other. Here, the neutralization switches corresponding to the data lines R, G, and B are defined as neutralization switches 50r, 50g, and 50b respectively. The neutralization switches 50r, 50g, and 50b are controlled by the control signals CR, CG, and CB output from the control block 11.

Those neutralization switches are connected in two ways. In one way, a neutralization line 54, which is a low resistance wiring material, is used and in the other way, the line 54 is not used. The neutralization line 43 is not connected to any power supplies including a precharging power supply.

In FIG. 2, the neutralization line 54 is used. One end of each neutralization switch 50 is connected to a data line (output terminal) and the other end thereof is connected to the neutralization line 54. In this case, the voltage of each connected data line is stabilized around the reference voltage (common voltage) after neutralization, thereby it is hardly affected by image data. This is a merit of using the neutralization line 54. On the other hand, the on-resistance between data lines rises more than when the neutralization line 54 is not used. This is a demerit of using the neutralization line 54. For example, the on-resistance of the neutralization switch between the red data line R1 and the green data line G1 becomes equal to the total value of the two on-resistance values of the neutralization switches 50r and 50g.

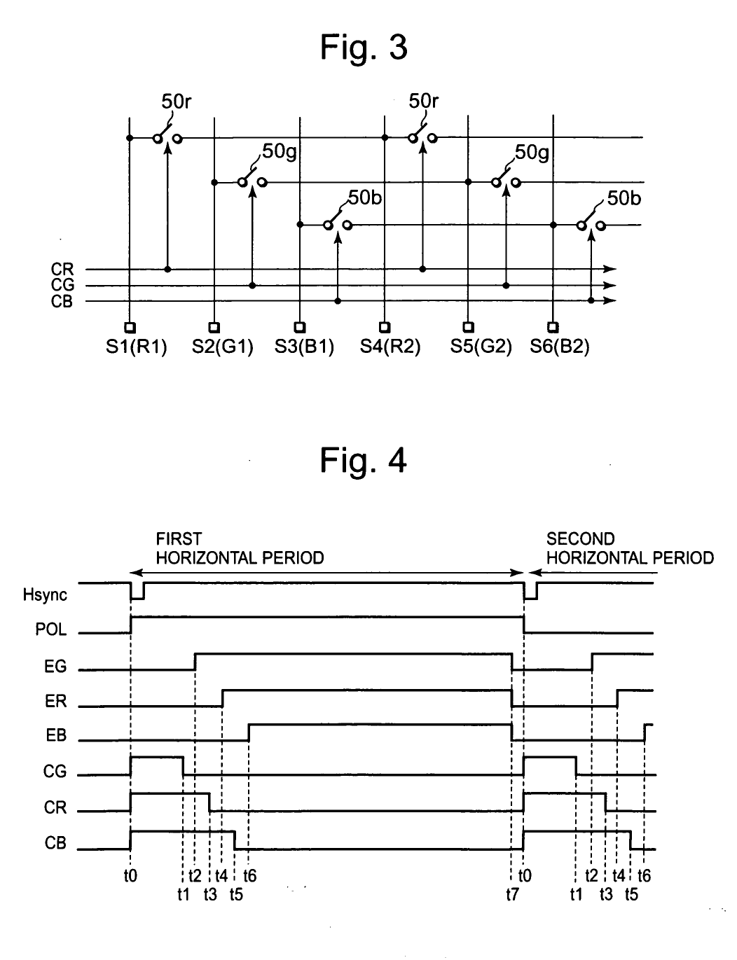

Next, there will be described the other case in which the neutralization line 54 is not used with reference to FIG. 3. It is premised here that a neutralization switch is provided between adjacent same color data lines. For example, the neutralization switch 50r is provided between red data lines R1 and R2. Similarly, the neutralization switch 50g is provided between green data lines G1 and G2 and the neutralization switch 50b is provided between blue data lines B1 and B2. When the neutralization line 54 is not used, the on-resistance between adjacent data lines is lower than when the neutralization line 54 is used. However, because the on-resistance between far data lines is high, it is easily affected by image data, thereby the voltage goes unstable after neutralization. This might affect the voltage for writing in pixels. This case in which the neutralization line 54 is not used can also apply to the second and third exemplary embodiments to be described later.

In any way, because there is no precharge voltage supply, the voltage of each neutralized data line goes unstable, thereby the voltage comes to be fluctuated by image data. However, as described above, in a charge neutralization process, the charge accumulated in a data line is just moved to another place through a neutralization switch. Thus the current is not concentrated in any power supply line of the driving block. Thus the EMI can be reduced.

Each switch of the output switch block 40 and the neutralization switch block 50 can consist of a CMOS type transfer gate composed of pMOS and nMOS transistors. Although not illustrated here, if a control signal controls each n-type transistor of the transfer gate, an inverter can be provided just before each p-type transistor. In this case, however, the number of inverters increases. To avoid this problem, therefore, the control block 11 generates inverted control signals from control signals and uses those inverted control signals to control the p-type transistors commonly. Actually, therefore, three control signals and three inverted control signals are used to control the neutralization switch block 50. Similarly, three control signals and three inverted control signals (six in total) are used to control the output switch block 40. Here, only the control signals are shown and no inverted control signals are shown to simplify the drawing.

According to the present invention, it is premised that all the switches of the output switch block 40 and the neutralization switch block 50 are turned on when the subject control signal denotes the H level and those switches are turned off when the control signal denotes the L level.

Next, there will be described the operation of the driving block in detail with reference to the timing chart shown in FIG. 4. At first, control signals CG, CR, and CB go into the H level at the time t0 of the horizontal period, thereby all the neutralization switches 50 are turned on. In case of a charge neutralization process, no current flows into the power supply line. So, the charge neutralization is started for all of the RGB colors simultaneously. At this time, the logic block transfers image data latched in the latch A to the latch B. When such image data as a horizontal stripe pattern, a checker pattern, or the like changes, the level shift is inverted, thereby the current increases. However, if this latching period is shifted temporally for each color, the EMI can be reduced. At the time t1, the control signal CG goes into the L level, thereby the neutralization switch 50g is turned off. At the time t2, the control signal EG goes into the H level, thereby the neutralization switch 40g is turned on and a gradation signal is supplied to the green data line G in accordance with the object image data. At the time t3, the control signal CR goes into the L level, thereby the neutralization switch 50r is turned off. At the time t4, the control signal ER goes into the H level, thereby the neutralization switch 40r is turned on and a gradation signal is supplied to the red data line R in accordance with the object image data. At the time t5, the control signal CB goes into the L level, thereby the neutralization switch 50b is turned off. At the time t6, the control signal EB goes into the H level, thereby the neutralization switch 40b is turned on and a gradation signal is supplied to the blue data line B in accordance with the object image data. And just before the time T7, the scanning lines are deactivated and the image TFT is turned off, thereby a gradation signal is held in each pixel. At the time t7, the control signals ER, EG, and EB go into the L level, thereby the output switches 40r, 40g, and 40b are turned off.

The operation timings of the driving block are as described above, that is, those timings are controlled so that the charge neutralization period comes to differ among color data lines. This means that a relationship Tcsg<Tcsr<Tcsb is assumed among the charge neutralization period Tcsg (between to t0 t3) of the green data line G, the charge neutralization period Tcsr (between t0 to t3) of the red data line R, and the charge neutralization period Tcsb (between t0 to t5) of the blue data line B. The charge neutralization period Tcsg of the green data line G is set shorter than the conventional simultaneous charge neutralization period. Consequently, the gate width Wcsg of the transistors of the neutralization switch 50g corresponding to the green data line G should preferably be set larger than those of the neutralization switches 50r and 50b corresponding to the data lines R and B to lower its on-resistance and shorten the charge neutralization period (between t0 and t1).

And a relationship Tdvg>Tdvr>Tdvb is assumed among the driving period Tdvg (between t2 to t7) of the green data line G, the driving period Tdvr (between t4 to t7) of the red data line Tdvr, and the driving period Tdvb (between t6 to t7) of the blue data line Tdvb. It is also assumed that the driving period Tdvg of the green data line G is set longer than those of other color data lines. When compared with the conventional case, each of the data line driving periods Tdvg, Tdvr, and Tdvb is extended just by the shortened part of the charge neutralization period Tcsg.

It is also possible to set the gate width of the transistors of the output switch 40 differently among colors. And because the driving period of the last data line to be driven becomes short, the on-resistance of the output switch is set low to raise the through rate. This can improve the rate of writing into pixels.

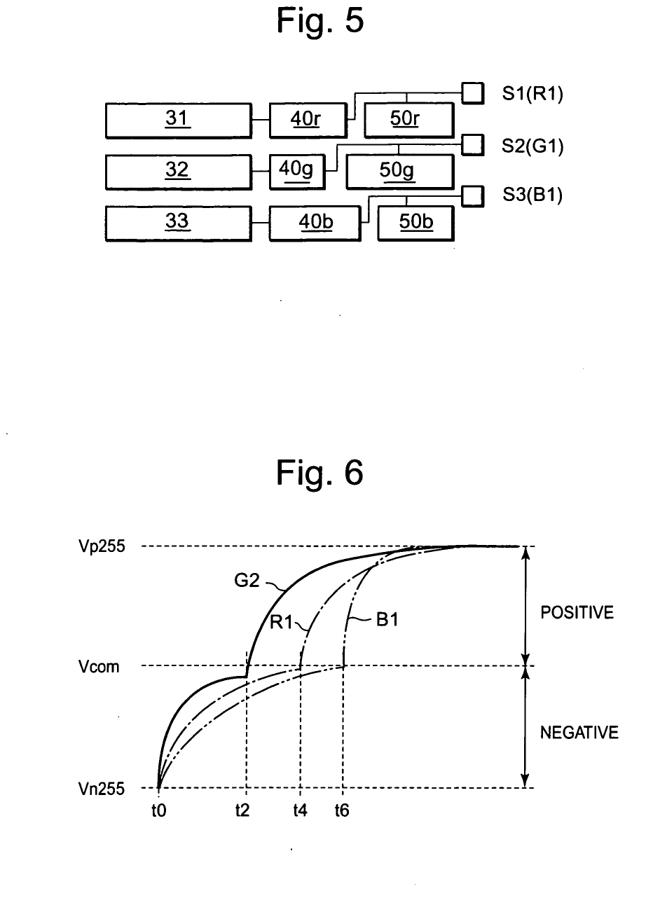

If it is premised that the gate width Wcs of the neutralization switches 50r, 50g, and 50b are Wcsr, Wcsg, and Wcsb, the relationship should preferably be Wcsg>Wcsr<Wcsb or Wcsg>Wcsb>Wcsr. The relationship Wcsg=Wcsr=Wcsb may also be possible. The on-resistance of the neutralization switch 50g corresponding to the green data line G is set smaller than those of the neutralization switches 50r and 50b corresponding to other color data lines R and B. On the contrary, if it is premised that the gate widths Wo of the output switches 40r, 40g, and 40b are Wor, Wog, and Wob, the relationship should preferably be Wog<Wor<Wob or Wog<Wob<Wor. However, the relationship Wog=Wor=Wob may also be possible. Furthermore, the relationship should preferably be Wcsg+Wog=Wcsr+Wor=Wcsb+Wob. FIG. 5 is a diagram for showing the layout area of the output switches 40 and the neutralization switches 50. The gate length L is the minimum gate length, so the gate width W is proportional to the layout area.

If the transistor gate width W is wide, then the gate capacity is expanded. So, the driving power of the buffer for outputting switch control signals increases. On the other hand, if the transistor gate width W is narrow, then the gate capacity shrinks. So, the driving power of the buffer for outputting switch control signals decreases.

FIG. 6 is a diagram for showing the signal waveforms of data lines when the relationship among them is Wcsg<Wcsr<Wcsb and Wog<Wor<Wob. Here, there will be described a signal waveform to appear with respect to the gradation of every data line in the first horizontal period when the negative polarity gradation voltage Vn255 changes to the positive polarity gradation voltage Vp255. At the time to, the subject charge neutralization process begins and the on-resistance difference among the neutralization switches generates a waveform difference, thereby the through rate of the charge neutralization of the green data line G2 becomes higher than those of the data lines R1 and B1 for other colors. On the contrary, the gradation signal through rate of the blue data line B1 becomes higher than those of the data lines G2 and R1 for other colors. Consequently, even when the driving period of the blue data line B to be driven last is short, because its through rate is high, the rate of writing into pixels can be improved. The gradation signal of the blue data line B may pass the gradation signal of the red data line R, although it depends on the output timing of the gradation signal and the on-resistance value of the output switch.

In this exemplary embodiment, the output timing is varied among the gradation signals to temporally disperse the current flown into the power supply line so as to reduce the EMI. Furthermore, the neutralization switch of each color is controlled so as to vary the length among the periods of those colors. Particularly, the charge neutralization period of the data neutralization period of green of which visual sensitivity is high is shortened to extend the driving period of the subsequent green data line G. When the charge neutralization period of the green data line G is shortened in such a way, the driving period of each color is extended more than conventionally. As a result, the rate of writing into pixels, as well as the contrast are improved.

### Second Exemplary Embodiment

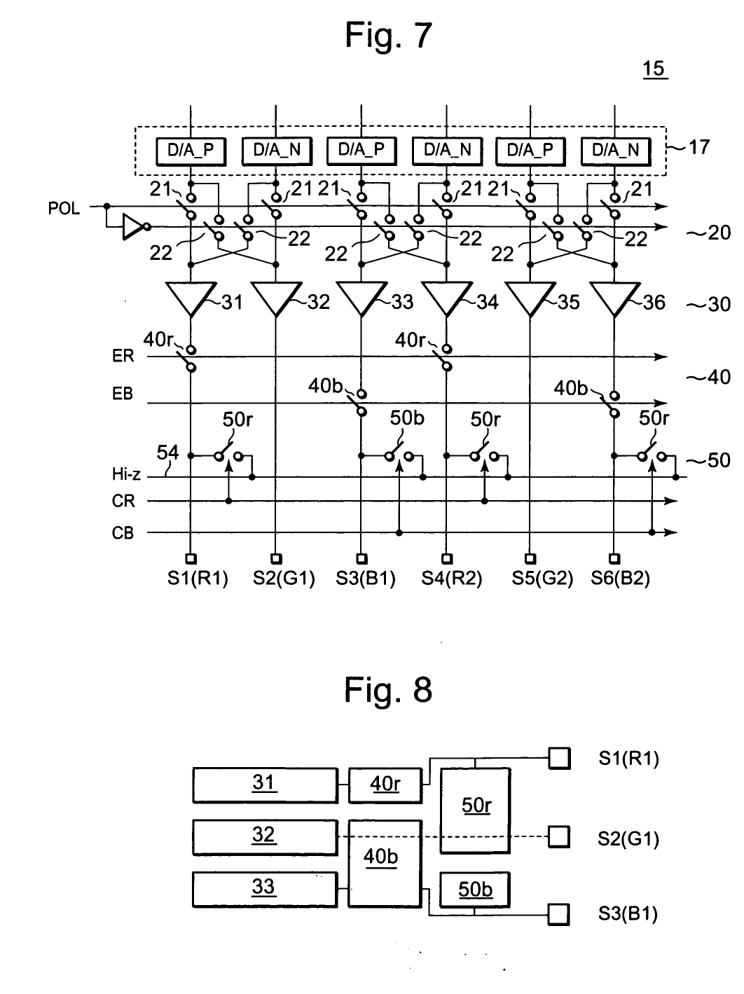

In this second exemplary embodiment, the charge neutralization period of the green data line G is omitted to further improve the rate of writing into pixels. FIG. 7 shows a detailed circuit diagram of the driving block 15. In FIG. 7, the neutralization switch 50g and the output switch 40g corresponding to the green data line G respectively are omitted. This is only a difference from FIG. 2. In this second exemplary embodiment, therefore, the drive IC can be reduced more in size.

With respect to the gate widths of the transistors provided in both the neutralization switch and the output switch, the relationship should preferably be Wcsr>Wcsb or Wcsr<Wcsb and Wor<Wob or Wor<Wob. The relationship may also be Wcsr=Wcsb and Wor=Wob.

In FIG. 8, the output switch 40b is given an area that is equivalent to the omitted part of the green output switch 40g while the red neutralization switch 40r is given an area that is equivalent to the omitted part of the green neutralization switch 50g. This means that Wcsr=2×Wcsb and 2×Wor=Wob are satisfied.

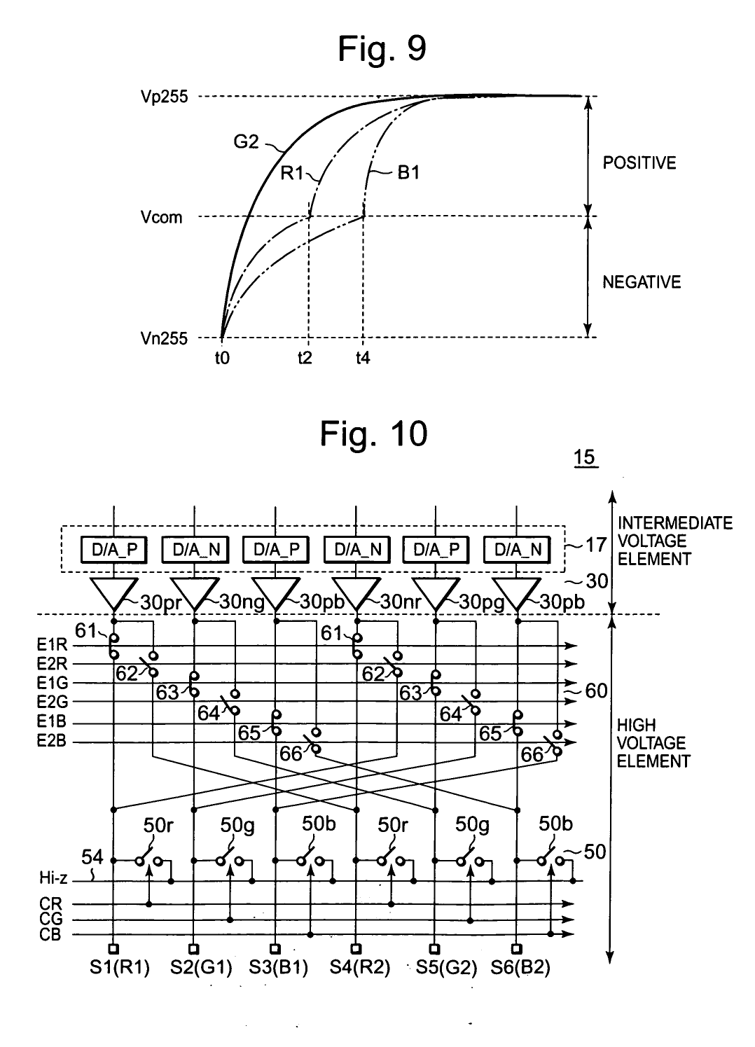

FIG. 9 shows the signal waveform of each data line. The green data line G2 has no charge neutralization period, so the gradation signal output begins at the time t0. As a result, the neutralization switches 50r and 50b are turned on. And at the time t1, the neutralization switch 50r is turned off. At the time t2, the output switch 40r is turned on to output a gradation signal to the red data line R. At the time t3, the neutralization switch 50b is turned off. At the time t4, the output switch 40b is turned on to output a gradation signal to the blue data line B. In this exemplary embodiment, the timing of the red data line R is almost the same as that of the green data line G in the first exemplary embodiment. Consequently, the charge neutralization period becomes shorter than that in the first exemplary embodiment, thereby the driving period of each color is extended. As a result, the rate of writing into pixels is improved.

In this exemplary embodiment, there is no charge neutralization carried out for the green data line G and no output switch is provided for the green data line G. This is why it is required to set the output impedance of the buffers 32 and 35 higher than those of the buffers corresponding to the data lines R and B so as to prevent the increase of the peak current flowing into the power supply line through the buffer corresponding to the green data line G. In this case, only the neutralization switch 50g may be omitted while the output switch 40g is left over as is.

When compared with the first exemplary embodiment, this second exemplary embodiment has a demerit. Because the charge neutralization rate becomes 0 with respect to ⅓ of the total number of data lines, the power consumption comes to increase to make up for the charge neutralization rate 0. Even in this case, however, the power consumption is still smaller than that of the precharging.

### Third Exemplary Embodiment

Next, there will be described what are different from the first exemplary embodiment with reference to FIG. 10. The data line driving block in this third exemplary embodiment includes a positive polarity driving block that works within a supply voltage range between the low voltage GND and the high voltage VDD and a negative driving block that works in the supply voltage range between the low voltage VSS and the high voltage GND in order to reduce the sizes of the D/A conversion block 17 of the driving block 15 and the buffer block 30, as well as to lower the power consumption. In FIG. 10, the positive polarity driving block includes a D/A converter D/A_P and a buffer 30p while the negative polarity block includes a D/A converter D/A_N and a buffer 30n. The voltages are set, for example, as GND=0V, VDD=9V, and VSS=−9V. Each of the positive and negative polarity driving blocks operates with half a voltage of the liquid crystal driving voltage (VDD−VSS). In another example, voltages can be set as the low voltage GND of the positive polarity driving block=0V, the high voltage VDD of the positive polarity driving block=9V, the low voltage VSS of the negative polarity driving block=−6V, and the high voltage VDD of the negative polarity driving block=2V. The voltage amplitude may differ between the positive driving block and the negative polarity driving block just like the voltage amplitude that is 9V in the positive polarity driving block and 8V in the negative polarity driving block. Furthermore, the low voltage of the positive polarity driving block and the high voltage of the negative polarity driving block may be changed to another respectively. In this exemplary embodiment, the technique disclosed in Japanese Unexamined Patent Application Publication No. 2006-106657 by the present invention is employed to separate the positive polarity driving block from the negative polarity driving block with an N well or the like provided therebetween so that they are used in different power supply ranges.

The buffer block 30 consists of a buffer 30pr that outputs positive polarity gradation signals to the red data lines R1 and R2; a buffer 30nr that outputs negative polarity gradation signals to the green data lines R1 and R21; a buffer 30pg that outputs positive polarity gradation signals to the green data lines G1 and G2; a buffer 30ng that outputs negative polarity gradation signals to the green data lines G1 and G2; a buffer 30pb that outputs positive polarity gradation signals to the blue data lines B1 and G2; and a buffer 30nb that outputs negative polarity gradation signals to the blue data lines B1 and B2. The positive and negative polarity driving blocks are medium voltage elements having a withstand voltage of about 10V respectively.

A polarity switching block 60 is provided between each data line and the buffer block 30. The polarity switching block 60 has output and polarity switching functions. The polarity switching block 60 is a high voltage element having a withstand voltage of about 20V. A switch 61 is provided between the buffer 30pr and the data line R1 and between the buffer 30nr and the red data line R2 respectively. And a switch 62 is provided between the buffer 30pr and the data line R2 and between the buffer 30nr and the red data line R1 respectively. And a buffer 63 is provided between the buffer 30ng and the green data line G1 and between the buffer 30pg and the green data line G2 respectively. A switch 64 is provided between the buffer 30ng and the green data line G2 and between the buffer 30pg and the green data line G1 respectively. A switch 65 is provided between the buffer 30pb and the blue data line B2 and between the buffer 30nb and the blue data line B2 respectively. A switch 66 is provided between the buffer 30pb and the blue data line B2 and between the buffer 30nb and the blue data line B1 respectively. The switches 61 to 66 are controlled by the control signals E1R, E2R, E1G, E2G, E1B, and E2B respectively. The gate width of the transistors of each switch should preferably differ among colors just like in the first exemplary embodiment.

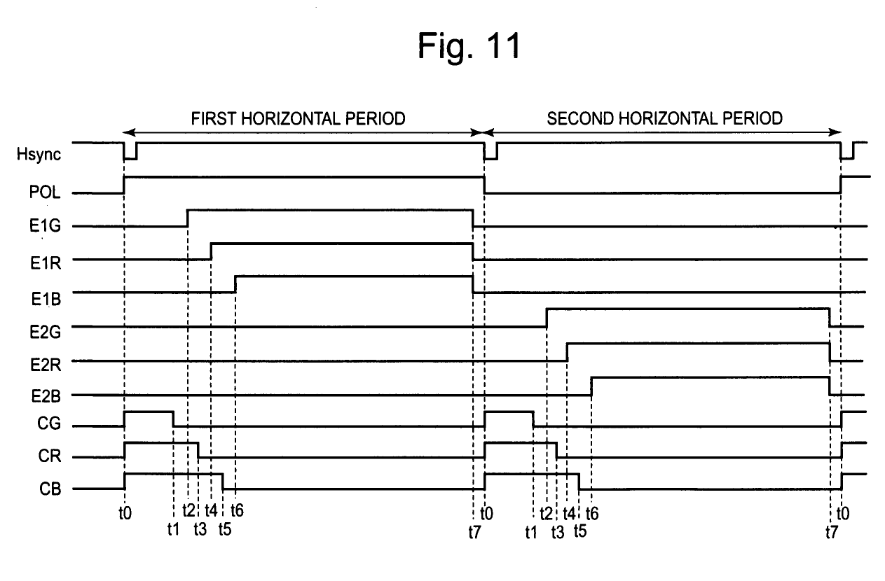

FIG. 11 shows a timing chart. In the first horizontal period (polarity signal POL=H level), the control signals E1R, E1G, and E1B are activated at the same timings as those of the control signals ER, EG, and EB described in the first exemplary embodiment. The control signals E2R, E2G, and E2B are kept on the L level respectively. In the second horizontal period (polarity signal POL=L level), the control signals E1R, E1G, and E1B are kept on the L level respectively. The control signals E2R, E2G, and E2B are activated at the same timings as those of the control signals ER, EG, and EB described in the first exemplary embodiment.

While the first to third exemplary embodiments of the present invention have been described above, the output impedance of each buffer might change, thereby the buffer might oscillate in those exemplary embodiments. Such buffer oscillation can be prevented by changing the size of the transistors of the buffer or by adjusting the bias current and the phase compensation capacity. A buffer, when it is described as a voltage follower, may be replaced with an amplifier having a gain over one. When the amplifier gain that is over one makes it possible to reduce the D/A conversion block 17 in size and lower the power consumption, as well as delete the level shift provided between the logic block 13 and the driving block 15, thereby the driver IC can further be reduced in size and in power consumption.

Each transistor in the output stage of the buffer may also be provided with an output switch function. This technique is already disclosed by the present inventor in Japanese Unexamined Patent Application Publication No. 2007-156235. Each transistor in the output stage of the buffer is controlled differently among colors.

While the blue data line B is driven last, the order of the R and B may be changed so that the red data line R is driven last.

While the data line driving block 10 is formed on a semiconductor chip in the above exemplary embodiments, part or whole of the circuit may be formed on a panel substrate on which pixels are formed. For example, it is also possible to form neutralization switches on the panel substrate and control those switches with control signals output from a driver IC. If a neutralization switch is provided at both sides of a data line, the charge neutralization period can further be shortened.

While three primary colors RGB have been described as the subject colors, white (W) may also be added to those RGB. In this case, the W (white) has no color filter, so its visual sensitivity comes to be higher than that of green. Thus the driving periods should preferably be controlled so as to become longer in the order of W, G, R, and B or W, G, B, and R. According to the present invention, the driving timing differs among colors. So, when an array of pixels is composed of even numbered pixels, those pixels should be driven so that the polarity comes to be different between adjacent data lines. In this case, the same color pixels are driven with the same polarity gradation signals, thereby the common electrode voltage comes to fluctuate significantly. And in order to suppress the common electrode voltage from such fluctuation, the array of pixels should be determined like (W1, R1, G1, B1, W2, R2, G2, and B2). As a result, each pixel is driven so as to assume (+, −, +, −, −, +, −, +) in the first frame, (−, +, −, +, +, −, +, −) in the second frame, (+, +, −, +, −, −, +, −)in the second frame, or (+, +, +, +, −, −, −, −) in the first frame, −, −, −, −, +, +, +, +) in the second frame. In such a way, data lines are driven so that the polarity comes to be varied between the same color adjacent pixels (W1 and W2, R1 and R2, G1 and G2, B1 and B2). Even in case of an array of pixels that are R, W, G, B), (R, G, W, B), (R, G, B, W), or the like, the data lines are driven so that the polarity differs between adjacent pixels of the same color.

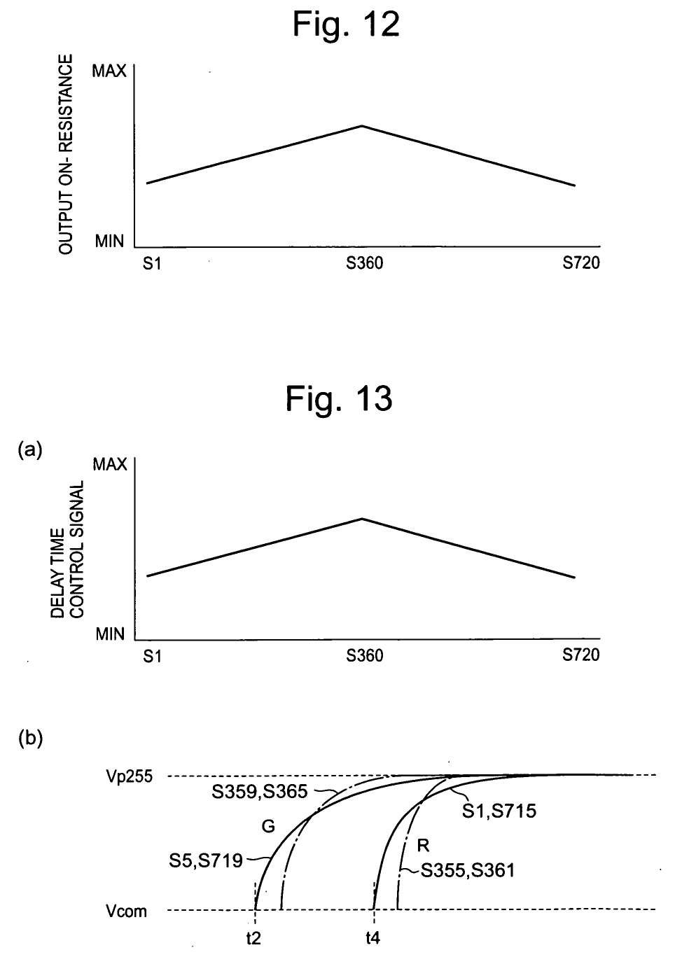

In case of the COG-implementation, the pad pitch (bump pitch) of the output terminal S of the driver IC is narrower than the data line pitch on the panel. Consequently, a routing line is required on the panel to connect the output terminal S to each of the data lines. For example, in case of a 720-output driver IC, the length of such a routing line on the panel becomes short around the S360 in the center portion of the driver IC, but long around S1 and S720 at both right and left sides of the driver IC. Consequently, the parasitic resistance of the output terminals at the right and left ends becomes higher than that in the center portion. If a waveform difference is generated between same colors, then the display color becomes uneven. Therefore, as shown in FIG. 12, the output impedance in the driver IC should preferably have high on-resistance in the center portion and low on-resistance at the right and left ends of the driver IC. And in order to change the on-resistance, it is also required to change the gate width Wo of the output switch 40. This means that it is required to change the gate width Wo of each of the output switches 40r, 40g, and 40b among colors and reduce the width Wo in the center portion and increase at the right and left ends of the driver IC even for the same color. There are also other methods for changing the on-resistance; one of the methods is to give a slope for the voltage of the control signals for controlling output switches and another method is to change the gate length L.

And as described above, it is also possible to supply a control signal that controls the output switch 40 to the center from both right and left ends of the driver IC, thereby increasing the delay time in the center of the driver IC as shown in FIG. 13A and delay the output timing in the center portion more than at the right and left ends even for the same color. This makes it possible to reduce the color unevenness to be caused by a varied resistance value of the routing line. As shown in FIG. 13B, it is also possible to reduce the EMI and suppress the color unevenness to be caused by a varied resistance value of the routing line by varying the output timing significantly among colors, thereby delaying the output timing slightly more in the center portion than that at the right and left ends of the driver IC even for the same color. Next, there will be described the timings shown in FIG. 13B in detail. At the time t2, positive polarity gradation signals are output from the output terminals S5 and S719 corresponding to the green data line G, then output from other output terminals (S11, S713, etc.) sequentially. After that, slightly after the time t2, positive polarity gradation signals are output from the output terminals S359 and S365. At the time t4, positive polarity gradation signals are output from the output terminals S1 and S715 corresponding to the red data line R. Then, positive polarity gradation signals are output sequentially from other output terminals (S7, S709, etc.). Then, slightly after the time t4, positive polarity gradation signals are output from the output terminals S355 and S361. Similarly, at the time t6, positive polarity gradation signals are output from the output terminals corresponding to the blue data line B (not shown). And almost at the same time, negative gradation signals are output from the output terminals. Because the dot inversion driving system is employed in this exemplary embodiment, the polarity is inverted for the next scanning period and signals are output at the same timings as those described above.

The method for varying the on-resistance value and the method for varying the delay time of control signals may also be combined. The present invention is not limited only to the exemplary embodiments described above; it is to be understood that modifications are apparent to those skilled in the art without departing from the spirit of the invention.

Further, it is noted that Applicant's intent is to encompass equivalents of all claim elements, even if amended later during prosecution.

What is claimed is:

1. A data line driving circuit provided for a display device having a plurality of data lines, comprising:
a first buffer that outputs a gradation signal in accordance with an image data, to a first data line;
a second buffer that outputs a gradation signal in accordance with an image data, to a second data line; and
a control block that controls so that a charge neutralization period of the first data line becomes shorter than a charge neutralization period of the second data line, and the gradation signal is output to the first data line earlier than the gradation signal output to the second data line.

2. The data line driving circuit according to claim 1,
wherein the data line driving circuit further includes:
a first neutralization switch corresponding to the charge neutralization of the first data line; and
a second neutralization switch corresponding to the charge neutralization of the second data line, and
wherein an on-resistance value of the first neutralization switch is smaller than that of the second neutralization switch.

3. The data line driving circuit according to claim 2,
wherein a gate width of a transistor of the first neutralization switch is wider than that of the second neutralization switch.

4. The data line driving circuit according to claim 1,
wherein the first data line corresponds to a green color and the second data line corresponds to another color.

5. The data line driving circuit according to claim 1,
wherein a through rate of the gradation signal of the second data line is higher than that of the first data line.

6. The data line driving circuit according to claim 1,
wherein the data line driving circuit further includes:
a first output switch provided between the first buffer and the first data line;
a second output switch provided between the second buffer and the second data line, and
wherein an on-resistance value of the first output switch is higher than that of the second output switch.

7. The data line driving circuit according to claim 6,
wherein a gate width of a transistor of the first output switch is narrower than that of the second output switch.

8. The data line driving circuit according to claim 6,
wherein a total value of gate widths of a transistor of the first neutralization switch and a transistor of the first output switch is equal to those of a transistor of the second neutralization switch and a transistor of the second output switch.

9. The data line driving circuit according to claim 1,
wherein the charge neutralization period of the first data line is substantially zero.

10. The data line driving circuit according to claim 9,
wherein there is no neutralization switch corresponding to the charge neutralization of the first data line.

11. The data line driving circuit according to claim 6,
wherein an on-resistance value of the first or second output switch is high in a center portion of a driver IC and low at right and left ends of the driver IC.

12. A display device having the data line driving circuit according to claim 1.

13. A data line driving method employed for a display device having a plurality of data lines, comprising:
controlling so that a charge neutralization period of a first data line becomes shorter than that of a second data line; and
controlling so that a gradation signal is output to the first data line earlier than a gradation signal output to the second data line.

14. The method according to claim 13,
wherein the charge neutralization period of the first data line is substantially zero.
